(19) United States
(12) Patent Application Publication
(10) Pub. No.: US 2026/0003608 A1
(43) Pub. Date: Jan. 1, 2026

(54) SYSTEMS AND METHODS FOR DYNAMIC SOFTWARE UPDATE

(71) Applicant: Acronis International GmbH, Schaffhausen (CH)

(72) Inventors: Vladimir Strogov, Singapore (SG); Alexey Kostyushko, Yerevan (AM); Aliaksei Dodz, Singapore (SG); Serg Bell, Costa del Sol (SG); Stanislav Protasov, Singapore (SG)

(21) Appl. No.: 18/758,639

(22) Filed: Jun. 28, 2024

(51) Int. Cl. G06F 8/656

(52) U.S. Cl. CPC G06F 8/656

(57) ABSTRACT

Systems and methods for dynamic software updating without update points. Software objects are updated at any moment during execution. Updating of object state (“upgrade”) is asynchronous with the update process. Delayed synchronization of state allows for control over timing and extent of state transitions.

### TECHNICAL FIELD

The invention relates generally to computerized software updating. More particularly, the invention relates to dynamic software updating (DSU) without using update points.

### BACKGROUND

Traditionally, software update is achieved by stopping running instances of the software (e.g. services or drivers), updating the binary, starting new instances of the software, and avoiding system reboot. However, certain security components should always be running, such as data loss prevention (DLP), antivirus, and active protection software. In particular, in the aforementioned scenario, the system is unprotected during the update process, and after updating without reboot, holes exist in the security perimeter, such as files, registry keys that were opened from the latest reboot before the update, and processes that were started from the latest reboot before the update. Further, it is not always possible to obtain control of system resources after updating that are present in the system starting from the latest reboot.

Accordingly, dynamic software updating (DSU) can be used to upgrade software while the software is running. However, DSU generally relies on update points, or specific moments or conditions under which updates are applied, often necessitating pauses or specific states in software execution that can interrupt continuity or limit flexibility. Therefore, there is a need for DSU systems and methods that operate without update points.

### SUMMARY

Embodiments described or otherwise contemplated herein substantially meet the aforementioned needs of the industry. Embodiments described herein include systems and methods to allow objects within software to be updated at any moment during execution, thereby maintaining operational continuity and reducing downtime. The actual update of the object state, referred to as the “upgrade,” is performed subsequently and is not bound by the immediate need to synchronize with the update process. This delayed synchronization of state (the upgrade) is executed granularly, permitting control over the timing and extent of state transitions. This granularity provides updates that are applied in a more controlled and efficient manner, improving both the stability of the system and its adaptability to changes.

In a feature and advantage of embodiments, DSU efficiency is improved by decoupling the update of code and data structures from their state transitions. Critical system functions remain uninterrupted and updates can be applied more flexibly and responsively to the needs of the system and its users.

In a feature and advantage of embodiments, DSU is improved by maintaining stateless binary data and stateful data, thereby reducing the complexity typically associated with state management in updates. Embodiments bypass the traditional dependence on specialized tools and compilers, instead utilizing its framework with minimal constraints. In one example, stateless data is updated and stateful data is upgraded.

Stateless data can be updated, for example, as data that are a part of a binary file, or sections of an executable file (e.g. pointers to the dynamic memory). Address space where the binary file resides is stateless. Stateful data can be upgraded, as this data resides in dynamic memory (e.g. address space of a process is stateful). Stateful data is not within the binary data.

In a feature and advantage of embodiments, and in contrast to traditional systems, no static analysis or specialized compiler is required due to the decoupling update of code and data structures from state transitions.

In a feature and advantage of embodiments, a layered approach to software updates is utilized. Updates can be applied at various granularities, such as individual elements such as grouped elements or the entire binary. Such a layer approach allows clear targeting of updates, from minor changes to major version upgrades, improving scalability and update accuracy.

In a feature and advantage of embodiments, extensions are employed to facilitate integration with third-party code. By utilizing such extensions, updates are guaranteed to be compatible and non-disruptive to external components.

In a feature and advantage of embodiments, software can be optionally downgraded by rolling back software from version N+1 to version N.

In an embodiment, a method for dynamic software updating without update points, the method comprises loading a new instance of a software (SW) component for version N+1, wherein each new instance is initialized in parallel with an existing instance of SW version N, and wherein each instance includes instance code, data, and data outside of binary; performing, by program control of a microprocessor operably coupled to memory, a first-stage update including: creating an intermediate placeholder for stateless data of SW versions N and N+1, copying stateless data of SW version N into the intermediate placeholder, configuring every code function of software version N+1 according to a function group in a complex form to work with data of SW version N and data of SW version N+1, detecting when the code and data of the instance of SW version N become inactive, and unloading the instance of SW version N; performing, by program control of the microprocessor, a first-stage upgrade including: creating at least one state-full extension for a plurality of objects of SW version N+1, upgrading stateless data of SW version N to SW version N+1 for per object basis such that the stateless data of N operates with state-full extensions of N and the stateless data of N+1 operates with the state-full extensions of N+1, freeing the state-full extensions of N, and repeating the upgrading and freeing for the plurality of objects of SW version N+1; and performing, by program control of the microprocessor, a second-stage update including: creating a final placeholder for the stateless data of SW version N+1, copying the stateless data of SW version N+1 from the intermediate placeholder into the final placeholder, setting function groups of code in N+1 to work compatibly with software version N+1, and freeing the intermediate placeholder.

In an embodiment, a system for dynamic software updating without update points, the system comprises at least one processor and memory operably coupled to the at least one processor; instructions that, when executed by the at least one processor, cause the at least one processor to implement: a loading engine configured to load a new instance of a software (SW) component for version N+1, wherein each new instance is initialized in parallel with an existing instance of SW version N, and wherein each instance includes instance code, data, and data outside of binary, a staged update engine configured to performing a first-stage update including: creating an intermediate placeholder for stateless data of SW versions N and N+1, copying stateless data of SW version N into the intermediate placeholder, configuring every code function of software version N+1 according to a function group in a complex form to work with data of SW version N and data of SW version N+1, detecting when the code and data of the instance of SW version N become inactive, and unloading the instance of SW version N; an upgrade engine configured to perform a first-stage upgrade including: creating at least one state-full extension for a plurality of objects of SW version N+1, upgrading stateless data of SW version N to SW version N+1 for per object basis such that the stateless data of N operates with state-full extensions of N and the stateless data of N+1 operates with the state-full extensions of N+1, freeing the state-full extensions of N, and repeating the upgrading and freeing for the plurality of objects of SW version N+1; and wherein the staged update engine is further configured to perform a second-stage update including: creating a final placeholder for the stateless data of SW version N+1, copying the stateless data of SW version N+1 from the intermediate placeholder into the final placeholder, setting function groups of code in N+1 to work compatibly with SW version N+1, and freeing the intermediate placeholder. In an embodiment, a method for dynamic software update comprises loading a software (SW) instance N+1 in parallel with an existing instance of SW version N; configuring every code function of software version N+1 according to a function group in a complex form to work with data of SW version N and data of SW version N+1; upgrading stateless data of SW version N to SW version N+1 for every object such that the stateless data of N operates with state-full extensions of N and the stateless data of N+1 operates with the state-full extensions of N+1; and setting function groups of code in N+1 to a pure version to only work compatibly with software version N+1.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for dynamic software updating without update points, according to an embodiment.

FIGS. 2A-2B are a flowchart of a method of dynamic software updating without update points, according to an embodiment.

FIG. 3 is a functional system diagram of a system for dynamic software updating including a first stage update, according to an embodiment.

FIGS. 4A-4B are block diagrams of system components for dynamic software updating including a first stage upgrade, according to an embodiment.

FIG. 5A is a functional system diagram of a system for dynamic software updating including a second stage update, according to an embodiment.

FIG. 5B is an alternative functional system diagram of a system for dynamic software updating including a second stage update, according to an embodiment.

FIG. 6 is a block diagram of data transformations, according to embodiments.

FIG. 7 are examples of list-based objects and tree-based objects, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Any running program can be thought of as a tuple (δ, P), where δ is the current program state and P is the current program code. Embodiments of dynamic software updating systems transform a running program (δ, P) to a new version (δ′, P′).

In an embodiment, systems and methods herein operate according to Formula 1 below:

$$( δ , P ) \to [ update stage 1 ] ( δ , complex {P}^{′} ) \to [ upgrade ] ( S ( δ ) , complex {P}^{′} ) \to [ update stage 2 ] ( {δ}^{′} , {P}^{′} ) \qquad ( Formula 1 )$$

Complex P′ or P″ operates with N and N+1, then complex code is reduced to be P′ or pure P′ and operates only with δ′ (N+1) data. As will be described, such functionality also allows for downgrading in case of errors. In addition, S(δ) reflects a transformation process from δ to δ′.

Accordingly, instead of reducing as in known solutions, more complex code is utilized in the respective middle. More particularly, a transformation is performed, then function groups of code of P′ are established to operate with δ′. In one aspect, the “complex code” refers to a temporary state where the code is set up to handle both the existing (N) and the new (N+1) versions of data during the update. For instance, if a function in the system manipulates user profiles, the complex form of this function would include mechanisms to interact with both the old data structure and a new, enhanced data structure until all data is fully upgraded.

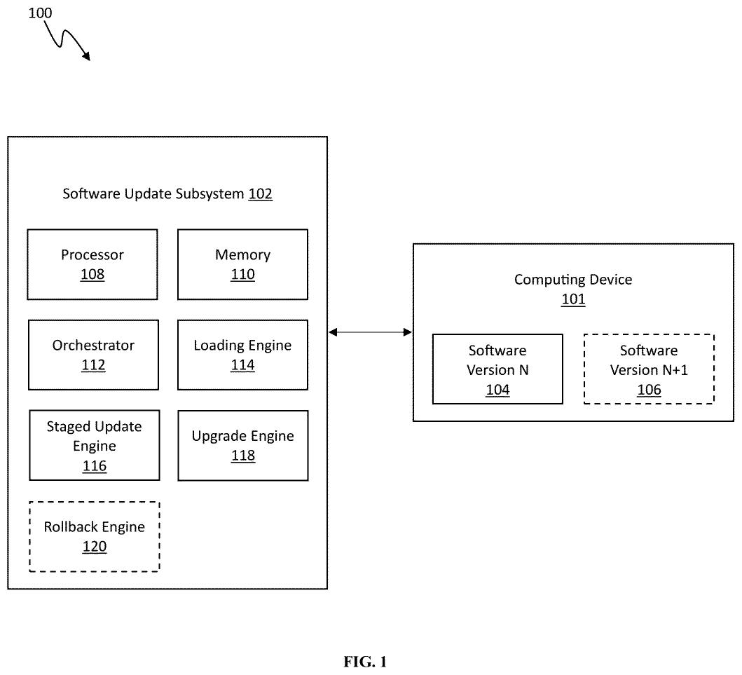

Referring to FIG. 1, a block diagram of a system 100 for dynamic software updating is depicted, according to an embodiment. In general, as described herein, system 100 operates without update points, in contrast to known existing solutions. More particularly, system 100 does not require update points to be defined, thereby eliminating pauses or specific states in software execution that can interrupt continuity or limit flexibility.

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware. An engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

System 100 generally comprises a computing device 101 and a software update subsystem 102. Computing device 101 comprises an electronic device operably coupled to software update subsystem 102 for dynamic software updating. In examples, computing device 101 can be desktop computer, a laptop computer, tablet, mobile computing device, server, workstation, or Internet-of-things (IoT) device, among other electronic devices.

In embodiments, as will be described, computing device 101 comprises a software version N 104 and a software version N+1 106. In embodiments, software version N 104 and software version N+1 106 comprise instructions that can be transformed into a form executable on computer hardware (such as computing device 101), or tools and methods needed to make the computing device 101, and can further comprise services, kernel-mode drivers, or dynamic-link libraries (DLLs). In one aspect, software version N 104 is a first, earlier-in-time version of the software as software version N+1 106, which is a second, later-in-time version of the same software. In embodiments, software version N 104 is upgraded to software version N+1 106.

Software update subsystem 102 is operably coupled to computing device 101 to update software version N 104 to software version N+1 106. Though computing device 101 and software update subsystem 102 are depicted as separate for ease of illustration, software update subsystem 102 or portions thereof can reside on computing device 101.

Software update subsystem 102 generally comprises a processor 108, a memory 110, an orchestrator 112, a loading engine 114, a staged update engine 116, an upgrade engine 118, and optionally a rollback engine 120.

Processor 108 is a programmable device that accepts digital data as input, is configured to process the input according to instructions or algorithms, and provides results as outputs. In an embodiment, processor 108 can be a central processing unit (CPU) configured to carry out the instructions of a computer program. Processor 108 is therefore configured to perform at least basic arithmetical, logical, and input/output operations.

Memory 110 is operably coupled to processor 108 and can comprise volatile or non-volatile memory as required by processor 108 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, memory 110 further comprises instructions that, when executed by processor 108, implement orchestrator 112, loading engine 114, staged update engine 116, upgrade engine 118, and rollback engine 120.

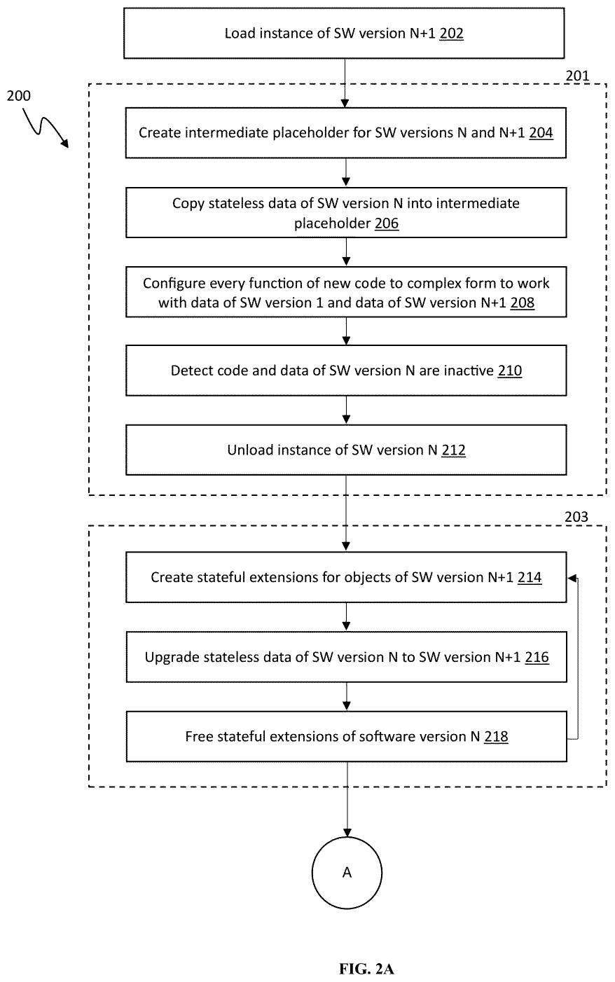

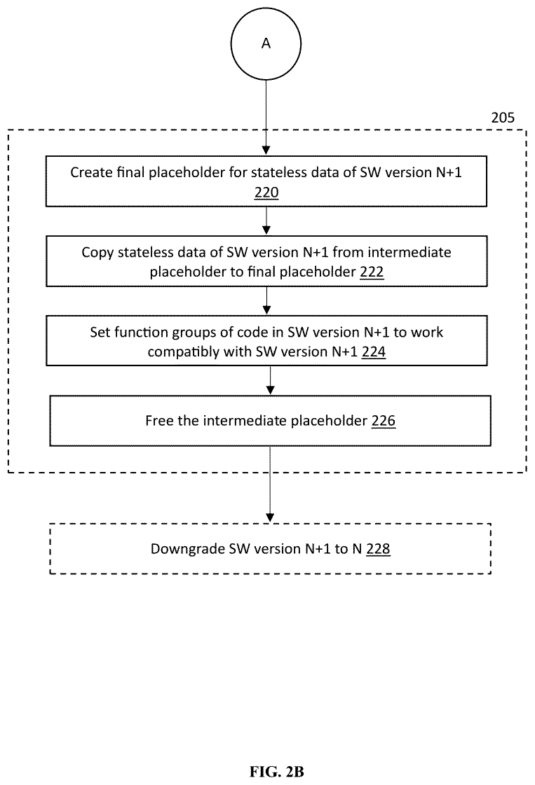

Orchestrator 112 is configured to manage software update requests of computing device 101. In an embodiment, orchestrator 112 is configured to receive software update requests and communicate information to one or more of the engines of software update subsystem 102 and interface to computing device 101. In one example, orchestrator 112 can be operably coupled to a processor (such as processor 108 and/or a processor of computing device 101—not shown in FIG. 2) via a system bus. In another example, orchestrator 112 can be operably coupled to computing device 101 via network interface.

Orchestrator 112 can further coordinate particular timing of operation(s) of loading engine 114, staged update engine 116, upgrade engine 118, and rollback engine 120, including individual function calls to the various engines. In one example, orchestrator 112 can direct the creation of intermediate placeholder(s) and copying of stateless data into the intermediate placeholders.

In an embodiment, orchestrator 112 can receive an update via a networked component. Orchestrator 112 can then check if software version N is in pure form. If software version N is in pure form, orchestrator 112 can start the update process. If software version N is not in pure form, the update is postponed until update and upgrade of version N−1 are completed to pure version N form. In another embodiment, orchestrator 112 can receive an instruction to perform a downgrade from version N+1 back to version N.

As to the update process itself, orchestrator 112 can request, via API, information about current final placeholders of version N and prepare intermediate placeholders, or orchestrator 112 can pass such information to software version N+1 so software version N+1 will perform the copy itself.

Loading engine 114 is configured to load instances of software components (such as services, kernel-mode drivers, DLLs, etc.) for new versions of software (e.g. version N+1 from version N). In one aspect, loading engine 114 is configured to initialize each new instance in parallel with existing instances of the previous version of software. Each instance can include, for example, instance code, instance data, and data outside of binary. In embodiments, instance code, instance data, and data outside of binary can be stored in dynamic memory, such as memory 110.

Staged update engine 116 is configured to perform a plurality of staged updates. In a first stage, a preparation sub-stage is utilized. In the preparation sub-stage, an intermediate placeholder is created and configured to store stateless data of software version N and/or stateless data of software version N+1. In one aspect, a list data structure is created as the intermediate placeholder data structure. In an embodiment, a single list is created for stateless data of software version N and stateless data of software version N+1. In another embodiment, a first list is created for stateless data of software version N, and a second list is created for stateless data of software version N+1. As will be described herein, the stateless data does not depend on software version.

In an embodiment, an initialization of the intermediate placeholder comprises (i) notification of instance N to send information required for the update; (ii) N+1 requesting N to update to N+1 by sending the information required, and (iii) orchestrator 112 managing updates and requests and sending all the information. In embodiments, the update is performed by (i)-(iii).

Further in the preparation sub-stage, the stateless data of SW version N is copied into the intermediate placeholder. In an embodiment, the stateless data of SW version N+1 is copied into an intermediate placeholder.

Further in the preparation sub-stage, every function of new code (e.g. the code instance of software version N+1) is configured to complex form (e.g. P″) ready to work with data of SW version N and data of SW version N+1. In one aspect, when there is a change in data structures from version N to N+1, all functions that work with such data exist with three forms:
(a) operation with version N data (old function);
(b) operation with both versions of data (complex form P″ of the new function), and
(c) operation with version N+1 (new function).

In an embodiment, a wrapper function can be utilized that will call either (b) or (c) depending on a global boolean variable.

In another embodiment, a function in (c) includes a check of a global boolean variable to be able to call a complex form (b).

In another embodiment, in order to be able to switch between (b) and (c), a function pointer is utilized. In order not to deal with each function pointer individually, a single array of function pointers can be implemented, thereby improving the resources needed to coordinate pointers. Accordingly, instead of changing a global boolean variable function, pointers are changed in such an array.

In another embodiment, in order to be able to switch between (b) and (c), a function pointer can be used. Accordingly, in order to avoid coordination with each function pointer individually two arrays of function pointers can be implemented. A first array is configured with (b) variants of functions and a second array is configured with (c) variants of functions. In operation, instead of changing a global boolean variable, a pointer to an array is switched.

In one aspect, only one switch per entire function set is made. In another aspect, such switches are performed with more granularity such that the function group is a subset of all functions that is switched as a whole subset. Accordingly, in an example if one group is defined, then this is a global switch. In another example, if the number of function groups are equal to the number of functions (e.g. one function in a group), every function can be managed individually.

In an embodiment, the number of function groups is related to the number of classes such that granularity is at the object level. When an object is upgraded, its virtual method table (VMT) is switched to (c) form.

In the first stage, a finalization sub-stage is utilized. More particularly, a finalization of the preparation stage is conducted, which can be done in parallel with the upgrade conducted by upgrade engine 118. In the finalization sub-stage, staged update engine 116 can detect when the code and data of the instance of software version N become inactive.

In an embodiment, the code and data of the instance of software version N can be detected as inactive by detecting when all reference counters for the instances of the SW version N components reach zero. In this example, there are no longer any active references to these components within the system.

In an embodiment, the code and data of the instance of software version N can be detected as inactive by performing stack unwinding to identify instances where function calls related to SW version N are no longer present in the call stack. In this example, a safe set of functions that do not interact with data and do not affect the activity status of SW version N can be detected but excepted.

In an embodiment, the code and data of the instance of software version N can be detected as inactive by monitoring bit-access, bit-presence, or page fault detection to determine if there is no recent access to the pages associated with the SW version N components. For example, bit-access and bit-presence involve monitoring memory access patterns to detect whether specific bits or memory pages are being accessed, which helps determine the activity status of components. Page fault detection tracks errors in accessing non-existent or swapped-out pages of memory, indicating inactive or obsolete data or code segments.

In one aspect, bits in page tables entries allow for tracking of data on a per-page basis. An access bit “on” indicates that data on the 4K page was accessed. A bit presence “off” indicates that access to 4K page will generate a page fault. Accordingly, data layouts can be organized such that data of versions N and N+1 is separated via pages (especially useful for extensions). In an embodiment, the aforementioned tracking can also be used as a method to monitor data.

In an embodiment, the code and data of the instance of software version N can be detected as inactive by analyzing the execution of the SW version N code within a secure enclave to detect a lack of execution flow into the enclave or checking for enclave termination conditions.

Once the code and data of the instance of software version N are detected as inactive, staged update engine 116 can unload the instance of software version N. In an embodiment, the first stage update operation of staged update engine 116 is then completed.

Upgrade engine 118 is configured to perform a first stage upgrade including creating stateful extensions for objects of software version N+1. The first stage upgrade includes transformation of the stateless data of N working with state-full extensions of N to the stateless data of N+1 that works with state-full extensions of N+1.

In an embodiment, the first stage upgrade can be started without status being “inactive.” In particular, the status of the instance/component does not necessarily need to be inactive to start an upgrade. Finalization of an upgrade is dynamic during the software version N operation because embodiments can start an upgrade, then detect when the code and data of the instance of SW version N become inactive, and unload the SW version N instance.

Stateful extensions are created by allocating additional memory or adapting existing data structures to extend their functionalities or to include new functionalities required by the new version (N+1). For example, if the original data model only tracked usernames and emails, a stateful extension could introduce support for tracking user activity history, which requires adjustments in memory allocation and data handling processes.

In order to be able to separate update and upgrade it is required that updated data (objects or structures) are stateless. For stateful data is thus kept with an extra pointer indirection. Such data is kept in additional chunks of dynamically-allocated memory called extensions, and stateless data only stores pointers to extensions.

When a stateless object/structure is updated, extensions are allocated for version N+1. An object (structure) is responsible to “upgrade” its data between extensions of version N and version N+1. An example of stateful data is an object with user info from a database, which is plainly stateful due to interaction with database storage. If there is an upgrade of database tables, then extensions are kept for both database tables (old and new) and only the business logic of the user info object can upgrade data between these extensions.

In an embodiment, the operation of creating stateful extensions can begin after staged update engine 116 operations of creation of the intermediate placeholder, copying the stateless data of software version N and N+1 into the intermediate placeholder, and setting the complex form. Accordingly, the finalization sub-stage in staged updated engine 116 does not block the first-stage upgrade processes.

In an embodiment, the creation of stateful extensions can be skipped by using indirection of data: address-block-pointer (return address). Accordingly, data is movable. A garbage collector is an example of movable property (one more indirection property) to achieve a delayed property. Everything stateful is placed in a separated block and thus update and upgrade are separated.

Upgrade engine 118 is further configured to upgrade the stateless data of SW version N to SW version N+1 on a per-object basis. In an embodiment, the stateless data of N that works with state-full extensions of N is converted to stateless data of N+1 that works with state-full extensions of N+1.

In an embodiment, upgrade engine 118 converts the one or most lists of the intermediate placeholder data structure(s) are converted to a final data structure. In one aspect, a final data structure is a tree. Accordingly, data elements in the list form are converted to the tree form. Accordingly, in the progress of upgrading, complex code works with both list (N) and tree (N+1). In an embodiment, a data transformation algorithm can comprise a conversion tool that transforms user data stored as plain text in list-based structures into encrypted formats organized in tree-based structures. The data transformation can include a combination of hash functions for quick data lookup and encryption algorithms for securing data, integrated seamlessly during the data upgrade process.

In one aspect, upgrade engine 118 uses version marker checking to determine a software version to operate with, as the system works with both versions (N and N+1) of software. When the upgrade is completed, version checking is no longer done.

With respect to the per-object basis of upgrading stateless data, callbacks that are registered in the system are linked with objects of components. Each reference counter shows a “link” of callback and objects. Accordingly, stateful data may include pointers to the code (callbacks). Further, other data without references can be updated. In an embodiment, each instance has corresponding objects.

Upgrade engine 118 is further configured to free the stateful extensions of software version N. In one aspect, freeing the stateful extensions includes freeing the resources used by the stateful extensions to prevent resource leakage.

Upgrade engine 118 is further configured to repeat the operations of upgrading the stateless data of SW version N to SW version N+1 and freeing the stateful extensions of software version N until every object is upgraded from version N to version N+1. In an embodiment, freeing the resources can be conducted at the time of operation on a new object, or in batch processing after many (or all) objects are upgraded.

Referring again to staged update engine 116, staged update engine 116 is further configured to perform a second stage update, including creating a final placeholder data structure for the stateless data of version N+1. In an embodiment, the final placeholder data structure comprises dynamic memory as a specially-allocated dynamic memory space configured to securely store the upgraded stateless data for SW version N+1 after it has been processed and is ready for use. The final placeholder data structure thereby serves as a temporary holding area until the data can be fully integrated into the system's operational datasets.

In an embodiment, the final placeholder data structure comprises a chunk of memory that is configured to store only stateless data of version N+1 and pointers to state-full extensions of version N+1. Moreover, there is no need to store any stateless data of version N or pointers to extensions of version N because the upgrade has been completed at this second stage.

Accordingly, upgrade engine 118 is further configured to copy the stateless data of version N+1 from the intermediate placeholder into the final placeholder.

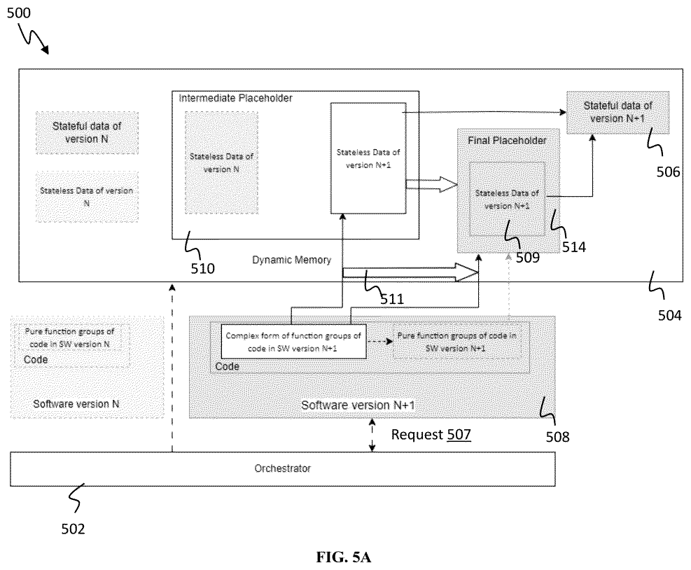

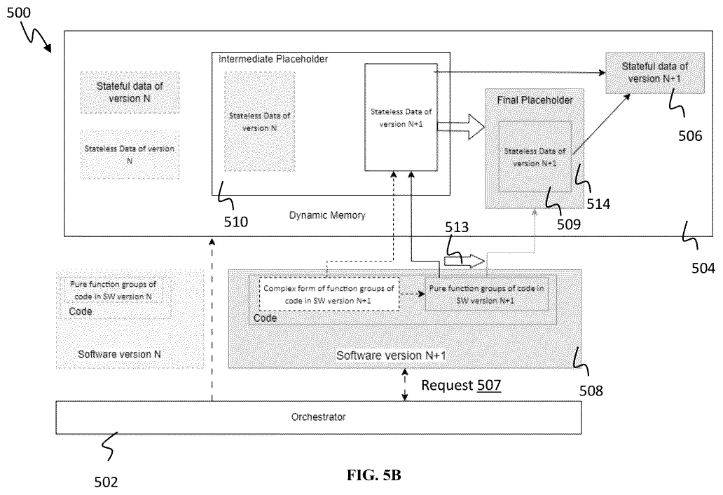

Upgrade engine 118 is further configured to set function groups of code in N+1 to work compatibly with software version N+1 (e.g. “pure form”). In one aspect, setting function groups of code in N+1 to work compatibly with software version N+1 includes aligning the functions of the software version with the newly updated data structures and operational protocols of N+1. For example, if software version N+1 introduces a new encryption protocol for data security, the function groups must be updated to encrypt and decrypt data using this new protocol instead of an old encryption protocol. Upgrade engine 118 is further configured to free the intermediate placeholder. In an alternative embodiment, as depicted and described in FIG. 5B, a switch to pure form can be made after the upgrade, and the second stage update can be subsequently performed.

In embodiments, the second stage update is done after the upgrading of stateless data of SW version N to SW version N+1 is completed. More particularly, the second stage update is performed once all the objects' data has been successfully upgraded from SW version N to SW version N+1, ensuring full completion of the upgrade process. This stage is important for optimizing performance as it eliminates the need to check version numbers or markers, thereby streamlining operations.

Advantageously, by using the staged update process, performance is improved. In one aspect, the overhead associated with maintaining compatibility with multiple data versions simultaneously is reduced, thereby decreasing memory usage by eliminating duplicate data storage, and increasing system responsiveness by finalizing the transition to the newer software version.

In another advantage of the staged update process, complex checks, for example, for synchronization sequences for proper syncing data portions of version N and data portions of version N+1 are eliminated.

In another advantage of the staged update process, the architecture allows for a further update from N+1 to N+2, because there is no data or code of software version N once updated from N to N+1. In particular, updating of version N+1 to version N+2 is allowed only after completion of the first-stage upgrade N to N+1 (thereby removing all aspects of software version N).

In one aspect, embodiments can be implemented for three or more software versions, such that the complex form can operate with version N−1 and N. In another aspect, embodiments can be implemented to operate with the K last versions such that complex form can operate with versions N−K+1 . . . . N. More particularly, complex forms can be compatible with not only software version N−1, but the prior K software versions.

In an embodiment, in order to allow the next update that cannot work with data of version N-X, staged update engine 118 ensures that no data of version N-X is present. Accordingly, staged update engine 118 is further configured to free memory storage for data of version N-X.

Moreover, for situations when it is desirable to work with one previous version after switching to a non-complex form of functions, embodiments thus operate only with single version N+1, thereby gaining performance.

Rollback engine 120 is configured to downgrade or roll back software versions. In an embodiment, rollback engine 120 is configured to detect one or more errors during the upgrade of stateless data or state-full extensions for each object. In one aspect, detection can be based on validation checks that confirm whether each object meets predefined criteria after its data has been upgraded.

Further, if one or more errors are detected, rollback engine 120 is further configured to perform a rollback process. In an embodiment, a rollback process comprises reverting the stateless data and stateful extensions of each object to their original state as per SW version N, thereby confirming that all changes made during the current upgrade session are undone. In an embodiment, the rollback process further comprises clearing any temporary data structures or placeholders created during the upgrade process, including the intermediate and final placeholders. In an embodiment, the rollback process further comprises resetting function groups of code to their configurations compatible with SW version N, thereby discontinuing the use of modifications intended for SW version N+1. In an embodiment, the rollback process further comprises prohibiting further execution of the second stage update. In one aspect, the second stage update is prohibited until the error(s) are resolved and the upgrade process can be safely restarted.

Referring to FIGS. 2A-2B, a flowchart of a method 200 of dynamic software updating without update points is depicted, according to an embodiment. In embodiments, method 200 can be implemented by the systems and system components described herein, such as system 100 by software update subsystem 102. In particular, method 200 can be coordinated by orchestrator 112.

At 202, a new instance of software version N+1 is loaded. For example, loading engine 114 can load a new instance of software components for SW version N+1 At 202, in an embodiment, each new instance is initialized in parallel with existing instances of SW version N.

Dashed grouping 201 comprises a first stage update that can be implemented by, for example, staged update engine 112. At 204, an intermediate placeholder is created for software for versions N and N+1. At 206, stateless data of software version N is copied into the intermediate placeholder. At 208, every function of the new code in software version N+1 is configured to operate with data of software version N and data of software version N+1. At 210, code and data of software version N are detected as inactive. At 212, software version N is unloaded.

Dashed grouping 203 comprises a first stage upgrade that can be implemented by, for example, upgrade engine 118. At 214, stateful extensions for objects of software version N+1 are created. At 216, the stateless data of software version N is upgraded to software version N+1. At 216, the stateful extensions of software version N are freed.

Referring further to FIG. 2B, dashed grouping 205 comprises a second stage update that can be implemented by, for example, staged update engine 112. At 220, a final placeholder for stateless data of software version N+1 is created. At 222, stateless data of software version N+1 is copied from the intermediate placeholder to the final placeholder. At 224, the function groups of code in software version N+1 are set to work compatibly with software version N+1. At 226, the intermediate placeholder is freed.

At 228, software version N+1 can be optionally downgraded to software version N. For example, rollback engine 120 can execute downgrade as coordinated by orchestrator 112.

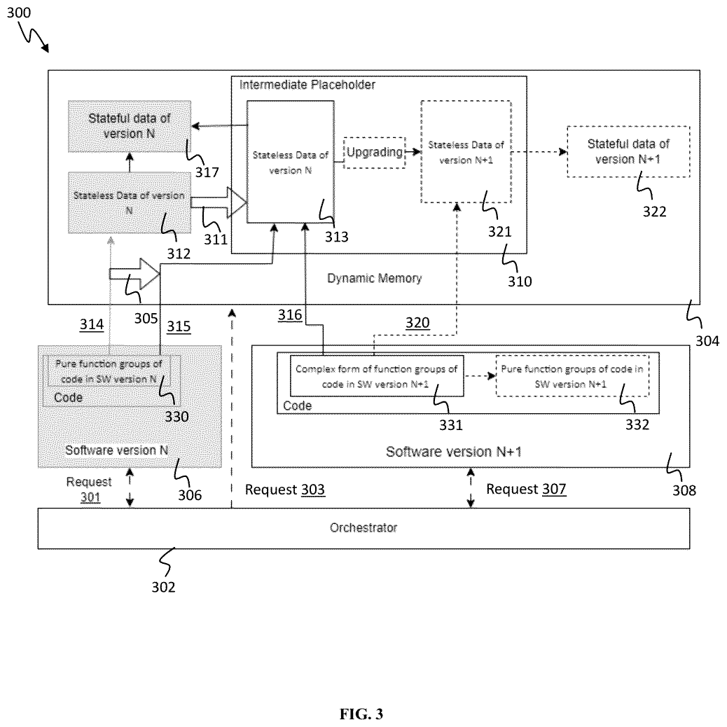

Referring to FIG. 3, a functional system diagram of a system 300 for dynamic software updating including a first stage update is depicted, according to an embodiment. System 300 comprises components similar to system 100, but which are renumbered in FIGS. 3-5 for ease of explanation. For example, the orchestrator depicted in FIG. 3 can be substantially similar to the orchestrator in FIG. 1, including the associated engines of software update subsystem 102. While the first stage update is generally depicted in FIG. 3, components that are executed or implemented outside of the first stage update are also included for ease of illustration.

System 300 generally comprises an orchestrator 302 operating on dynamic memory 304 that can coordinate the first stage update of software version N 306 to software version N+1 308 using an intermediate placeholder 310.

In operation, a request 301 from orchestrator 302 to software version N 302 requests information required for the update. In an embodiment, orchestrator 302 implements multiple API calls. In a first example API call, orchestrator 302 verifies that software version N 306 is in pure form 330 (so that update/upgrade from version N−1 was completed). In a second example API call, as will be described further below, in order to update placeholders, orchestrator 302 can gather placeholders from software version N 306 and: (a) pass the placeholders to version N+1; (b) create intermediate placeholders and pass both final placeholders gathered from software version N 306 and the created intermediate to software version N+1 308; or (c) gather final placeholders, create intermediate placeholders, copy information and initialize pointers to intermediate placeholders within orchestrator 302.

Software version N 302 can return the required information to orchestrator 302. In embodiments, software version N 302 comprises code including pure function groups of code. In response to request 301, software version N 302 can access dynamic memory including stateless data of version N and corresponding stateful data of version N.

At 303, orchestrator 302 communicates a request to dynamic memory 305 including any information from software version N 306. At 305, pointers of stateless data can be utilized to populate intermediate placeholder 310. As depicted, intermediate placeholder 310 can comprise stateless data of software version N. As will be described with respect to FIGS. 5A-5B, in the process of upgrading, stateless data of software version N+1. Stateful data of software version N+1 results, as will be described.

In an embodiment, at 305, pointer(s) content is switched or changed from the original placeholder to intermediate placeholder 310. In an embodiment, at 311, a process of copying of stateless data of version N 313 into the intermediate placeholder 310. Accordingly, together 305 and 311 is the implementation of so-called move semantics.

In embodiments, intermediate placeholder 310 is created according to two different aspects. In a first aspect, intermediate placeholder 310 can be created by orchestrator 302. For example, orchestrator 302 via 301 requests the size of stateless data of software version N 312. In another example, orchestrator 302 via 307 requests the size of the final placeholder associated with stateful data of software version N+1 322. In a second aspect, intermediate placeholder 310 can be created by software version N+1 308. For example, software version N+1 308 creates intermediate placeholder 310 because software version N+1 308 knows the sizes of stateless data of software version N 313 and stateless data of software version N+1 321.

With continued reference to 305, in a first aspect, update 305 can be conducted by orchestrator 302 via 301 requests 314 to stateless data of software version N 312. Further, if orchestrator 302 via 307 requests 313, orchestrator 302 performs update 305 via 314 and 315 and 311 via 312 and 313.

In a second aspect, 305 can be done by software version N 306. If orchestrator 302 requests via 307 the address of stateless data of software version N 313 (part of intermediate placeholder 310), orchestrator 302 sends via request 301 stateless data of software version N 313. Finally, software version N 306 performs update 305 via 314 and 315 and 311 via stateless data of software version N 312 to stateless data of software version N 313.

In an embodiment, initialization 316 can be performed. In a first aspect, initialization 316 can be conducted by orchestrator 302. For example, if orchestrator 302 requests via 307 the address of stateless data of software version N 313 (part of intermediate placeholder 310) and address of a variable to store initialized data, orchestrator 302 performs initialization 316. In a second aspect, initialization 316 can be conducted by software version N+1 308. For example, if orchestrator 302 via 301 requests size of 312, then orchestrator 302 via 307 sends stateless data of software version N 313 and software version N+1 308 performs initialization 316.

At 307, orchestrator 302 manages the request to update by the first stage of software version N+1 308. In an embodiment, software version N+1 308 comprises code including a complex form of function groups of code in software version N+1 to pure function groups of code in software version N+1.

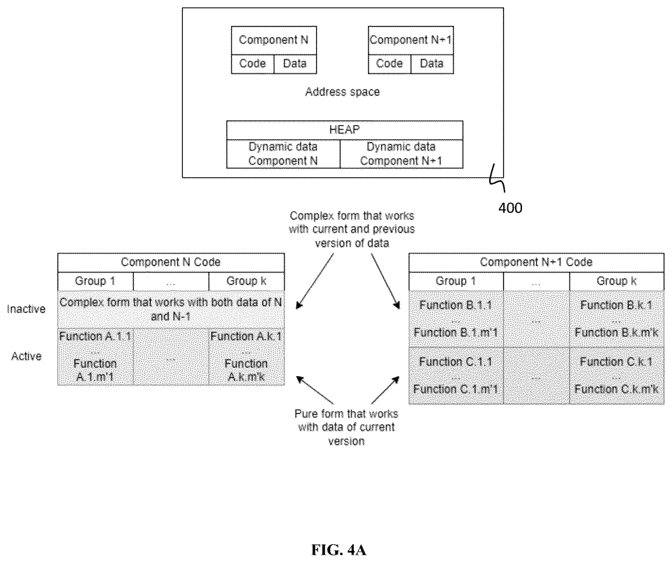

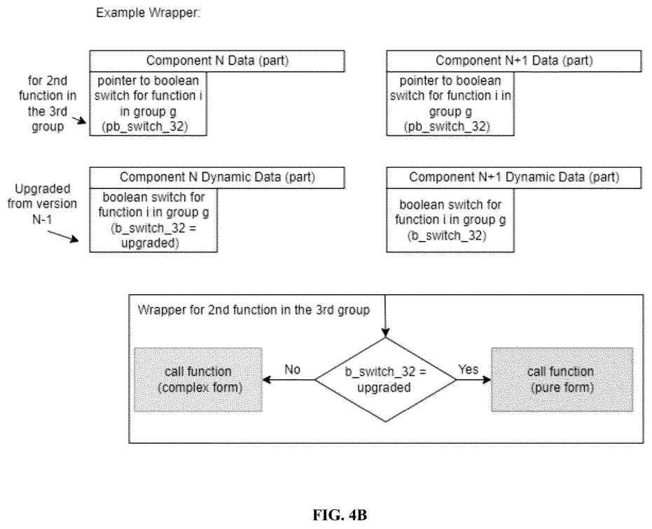

Referring to FIGS. 4A-4B, a block diagram of components of system 300 for dynamic software updating including a first stage upgrade are depicted, according to an embodiment. Address space 400 can be a portion of dynamic memory and comprises Component N including Component N associated code and data, as well as Component N+1 including Component N+1 associated code and data. Address space 400 further comprises a heap including dynamic data associated with Component N and dynamic data associated with Component N+1.

In an embodiment, when an executable binary exists in the address space, there exists dynamic data (in the heap or in the pool) created, for example, via malloc, a new operator or an ExAllocatePool API. Further, non-dynamic data can exist inside data sections of that binary. In an embodiment, all non-dynamic data is read-only constants (i.e. strings) or stateless pointers to the stateless movable objects (aka placeholders) in dynamic memory.

Further in FIG. 4A, Component N Code and Component N+1 Code are depicted with respect to complex forms that work with current and previous versions of data, as well as pure forms that work with the current version of data.

Referring to FIG. 4B, an example wrapper is depicted with respect to Component N data, Component N Dynamic Data, and Component N+1 data and Component N+1 dynamic data based on respective boolean switches are depicted. An example flowchart for an example wrapper for a 2^{nd} function in the third group is depicted with respect to the Boolean switch. For example, if b_switch_32 does not indicate an upgrade, the complex form of a function is called. If b_switch_32 indicates an upgrade, the pure form of a function is called.

Referring to FIG. 5A, a functional system diagram of system 500 for dynamic software updating including a second stage update is depicted, according to an embodiment. While the second stage update is generally depicted in FIGS. 5A-5B, components that are executed or implemented outside of the second stage update are also included for ease of illustration. Orchestrator 502 can create a final placeholder 514 data structure. Stateless data of software version N+1 509 can be copied from intermediate placeholder 510 to final placeholder 514 (for example, in dynamic memory 504). Stateful data of version N+1 506 results from stateless data of software version N+1. A request 507 from orchestrator 502 to software version N+1 508 can set function groups of code to complex form in software version N+1 508. At 511, pointers to stateless data are safely updated. Subsequently, orchestrator 502 can subsequently free intermediate placeholder 510.

More particularly, in an embodiment, creation of final placeholder 514 is done in similar way as described for FIG. 3: by orchestrator 302 (502 in FIGS. 5A-5B) or software version N+1 308 (508 in FIGS. 5A-5B). For example, with further reference to FIG. 3, all info is requested and sent via 301 and 307. Further, during the second stage update, similar to 305 via 314 and 315 and 311 via 312 and 313, during 311 copy 318 will automatically be generated.

Referring to FIG. 5B, an alternative functional system diagram of system 500 for dynamic software updating including a second stage update is depicted, according to an embodiment. In contrast to FIG. 5A, at 513 software version N+1 508 can be switched to pure form of function groups after the upgrade, and the second stage update can be performed subsequently.

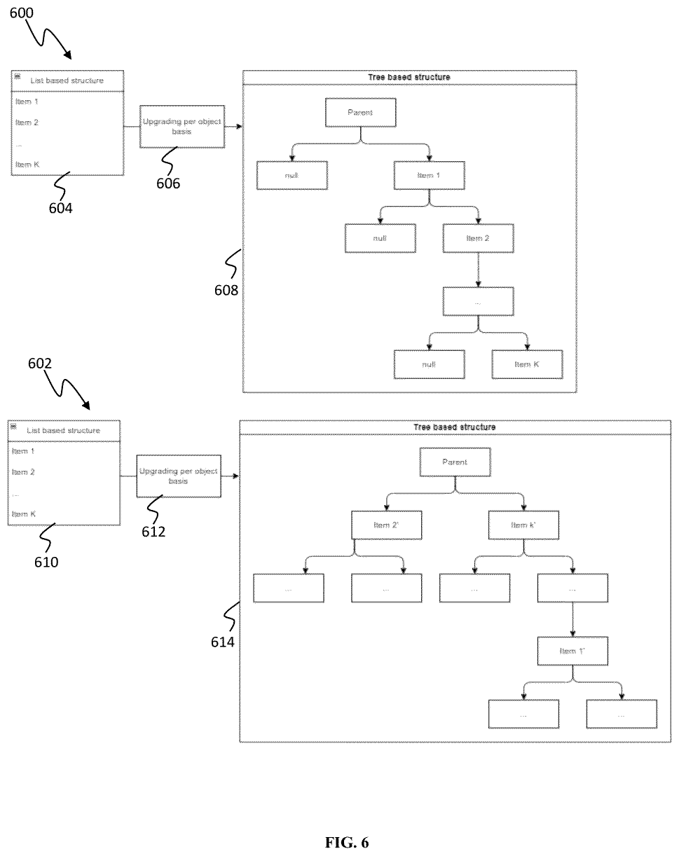

Referring to FIG. 6, a block diagram of data transformation 600 and data transformation 602 are depicted, according to an embodiment. In aspects, data transformations 600 and 602 are examples of an upgrade of a list structure to a tree structure, for example in a conversion of an intermediate placeholder data structure(s) to a final data structure.

Data transformation 600 comprises a list base structure 604 including a plurality of items (Item 1, Item 2 . . . . Item K). At 606, upgrading each object results in a tree-based structure 608. Tree-based structure 608 comprises a tree where every element of the list is a right element of the tree.

Data transformation 602 comprises a list base structure 610 including a plurality of items (Item 1, Item 2 . . . . Item K). At 612, upgrading each object results in a tree-based structure 614. Tree-based structure 614 comprises a balanced tree implemented by a balanced tree algorithm. Accordingly, data structures utilized can depend on the transformation algorithm chosen.

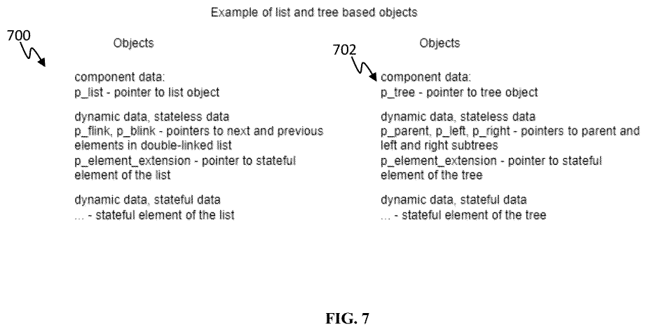

Referring to FIG. 7, examples of list-based objects and tree-based objects are depicted, according to an embodiment. Objects 700 comprise list-based objects. Objects 702 comprise corresponding tree-based objects.

1. A method for dynamic software updating without update points, the method comprising:
loading a new instance of a software (SW) component for version N+1, wherein each new instance is initialized in parallel with an existing instance of SW version N, and wherein each instance includes instance code, data, and data outside of binary;
performing, by program control of a microprocessor operably coupled to memory, a first-stage update including:
creating an intermediate placeholder for stateless data of SW versions N and N+1,
copying stateless data of SW version N into the intermediate placeholder,
configuring every code function of software version N+1 according to a function group in a complex form to work with data of SW version N and data of SW version N+1,
detecting when the code and data of the instance of SW version N become inactive, and
unloading the instance of SW version N;
performing, by program control of the microprocessor, a first-stage upgrade including:
creating at least one state-full extension for a plurality of objects of SW version N+1,
upgrading stateless data of SW version N to SW version N+1 for per object basis such that the stateless data of N operates with state-full extensions of N and the stateless data of N+1 operates with the state-full extensions of N+1,
freeing the state-full extensions of N, and
repeating the upgrading and freeing for the plurality of objects of SW version N+1; and
performing, by program control of the microprocessor, a second-stage update including:
creating a final placeholder for the stateless data of SW version N+1,
copying the stateless data of SW version N+1 from the intermediate placeholder into the final placeholder,
setting function groups of code in N+1 to work compatibly with software version N+1, and
freeing the intermediate placeholder.

2. The method of claim 1, further comprising a downgrade comprising:
detecting at least one error during the upgrade of stateless data or state-full extensions for each object;
initiating a rollback if the at least one error is detected, wherein the rollback includes:
reverting the stateless data and the state-full extensions of each object to respective original states according to the SW version N, thereby confirming that all changes made during a current upgrade session are undone,
clearing the intermediate placeholder and final placeholder, and
resetting function groups of code to configurations compatible with SW version N, thereby discontinuing the use of modifications intended for SW version N+1; and
prohibiting further execution of the second-stage update.

3. The method of claim 1, wherein updating of SW from version N+1 to SW version N+2 is allowed only after completion of the first-stage upgrade of the SW version N to the SW version N+1.

4. The method of claim 1, wherein updating of SW from SW version N to SW version N+k is allowed by setting function groups of code in the SW version N+k in complex form to operate with data of SW versions N to N+(k−1) and data of the SW version N+k.

5. The method of claim 1, wherein detecting when the code and data of the instance of the SW version N become inactive includes at least one of:
detecting when all reference counters for the instances of the SW version N code, data, and data outside of binary reach zero;
performing stack unwinding to identify instances where function calls related to SW version N are no longer present in the call stack; and
monitoring bit-access, bit-presence, or page fault detection to determine if there is no recent access to the pages associated with the SW version N code, data, and data outside of binary.

6. The method of claim 1, wherein upgrading stateless data of the SW version N to the SW version N+1 comprises employing algorithms for data transformation that facilitate the transition from at least one list-based structure in SW version N to at least one tree-based structure in SW version N+1.

7. The method of claim 1, wherein the method is iterated for the SW version N to the SW version N+1 to SW version N+2.

8. The method of claim 1, wherein the first-stage upgrade is performed asynchronously with the first-stage update and the second-stage update.

9. The method of claim 1, further comprising receiving a software update request and selectively executing the loading the new instance of a software (SW) component, the performing the first-stage update, the performing the first-stage upgrade, and the performing a second-stage update.

10. A system for dynamic software updating without update points, the system comprising:
at least one processor and memory operably coupled to the at least one processor;
instructions that, when executed by the at least one processor, cause the at least one processor to implement:
a loading engine configured to load a new instance of a software (SW) component for version N+1, wherein each new instance is initialized in parallel with an existing instance of SW version N, and wherein each instance includes instance code, data, and data outside of binary,
a staged update engine configured to performing a first-stage update including:
creating an intermediate placeholder for stateless data of SW versions N and N+1,
copying stateless data of SW version N into the intermediate placeholder,
configuring every code function of software version N+1 according to a function group in a complex form to work with data of SW version N and data of SW version N+1,
detecting when the code and data of the instance of SW version N become inactive, and
unloading the instance of SW version N;
an upgrade engine configured to perform a first-stage upgrade including:
creating at least one state-full extension for a plurality of objects of SW version N+1,
upgrading stateless data of SW version N to SW version N+1 for per object basis such that the stateless data of N operates with state-full extensions of N and the stateless data of N+1 operates with the state-full extensions of N+1,
freeing the state-full extensions of N, and
repeating the upgrading and freeing for the plurality of objects of SW version N+1; and
wherein the staged update engine is further configured to perform a second-stage update including:
creating a final placeholder for the stateless data of SW version N+1,
copying the stateless data of SW version N+1 from the intermediate placeholder into the final placeholder,
setting function groups of code in N+1 to work compatibly with SW version N+1, and
freeing the intermediate placeholder.

11. The system of claim 10, wherein the instructions that, when executed by the at least one processor, cause the at least one processor to further implement a rollback engine configured to:
detect at least one error during the upgrade of stateless data or state-full extensions for each object;
initiate a rollback if the at least one error is detected, wherein the rollback includes:
reverting the stateless data and the state-full extensions of each object to respective original states according to the SW version N, thereby confirming that all changes made during a current upgrade session are undone,
clearing the intermediate placeholder and final placeholder, and
resetting function groups of code to configurations compatible with SW version N, thereby discontinuing the use of modifications intended for SW version N+1; and
prohibiting further execution of the second-stage update.

12. The system of claim 1, wherein updating of SW from version N+1 to SW version N+2 is allowed only after completion of the first-stage upgrade of the SW N to N+1.

13. The system of claim 1, wherein updating of SW from SW version N to SW version N+k is allowed by setting function groups of code in the SW version N+k in complex form to operate with data of SW versions N to N+(k−1) and data of the SW version N+k.

14. The system of claim 1, wherein the staged update engine is configured to detect when the code and data of the instance of SW version N become inactive includes at least one of
detecting when all reference counters for the instances of the SW version N code, data, and data outside of binary reach zero;
performing stack unwinding to identify instances where function calls related to SW version N are no longer present in the call stack; and
monitoring bit-access, bit-presence, or page fault detection to determine if there is no recent access to the pages associated with the SW version N code, data, and data outside of binary.

15. The system of claim 1, wherein the upgrade engine is configured to upgrade stateless data of the SW version N to the SW version N+1 comprising employing algorithms for data transformation that facilitate the transition from at least one list-based structure in SW version N to at least one tree-based structure in SW version N+1.

16. The system of claim 1, wherein the system is iterated for the SW version N to the SW version N+1 to SW version N+2.

17. The system of claim 1, wherein the first-stage upgrade is performed asynchronously with the first-stage update and the second-stage update.

18. The system of claim 1, wherein the instructions that, when executed by the at least one processor, cause the at least one processor to implement further comprise:
an orchestrator configured to:
receive a software update request; and
selectively execute the loading engine, the staged update engine, and the upgrade engine.

19. A method for dynamic software update, comprising:
loading a software (SW) instance N+1 in parallel with an existing instance of SW version N;
configuring every code function of software version N+1 according to a function group in a complex form to work with data of SW version N and data of SW version N+1;
upgrading stateless data of SW version N to SW version N+1 for every object such that the stateless data of N operates with state-full extensions of N and the stateless data of N+1 operates with the state-full extensions of N+1; and
setting function groups of code in N+1 to a pure version to only work compatibly with software version N+1.

20. The method of claim 19, further comprising:
creating an intermediate placeholder for stateless data of SW versions N and N+1;
copying the stateless data of SW version N into the intermediate placeholder;
creating a final placeholder for the stateless data of SW version N+1; and
copying the stateless data of SW version N+1 from the intermediate placeholder into the final placeholder.
